(19) United States
(12) Patent Application Publication
(10) Pub. No.: US 2004/0230677 A1
(43) Pub. Date: Nov. 18, 2004

(54) System and method for securely monitoring and managing network devices

(76) Inventor: Roger John O'Hara, Billericay (GB)

Correspondence Address: MICHAEL B. JOHANNESEN, ESQ., LOWENSTEIN SANDLER, P.C., 65 LIVINGSTON AVENUE, ROSELAND, NJ, 07068, US

(21) Appl. No.: 10/667,752

(22) Filed: Sep. 22, 2003

Related U.S. Application Data
(60) Provisional application No. 60/471,308, filed on May 16, 2003.

(51) Int. Cl. G06F 15/16; G06F 15/173

(52) U.S. Cl. 709/224; 709/230

(57) ABSTRACT

A system and method isolates a network management system from the network components that it monitors and controls. A network management system is connected to a port other than the network port of the network components via a terminal server. The terminal server performs translations between communications to and from the serial ports and communications to and from the network management system. In this manner, connectivity between the management device and the network components is through a protocol which is not networkable, routable or both by the managed network device.

### FIELD OF THE INVENTION

This invention relates to the field of data networks, and, more specifically, to a system and method for securely monitoring and managing network devices.

### BACKGROUND OF THE INVENTION

Networking devices include, but are not limited to, routers, switches, firewalls and computers with networking abilities. Network devices are designed to connect together using a protocol such as TCP/IP. These devices have networking data ports which connect them to neighboring devices and thereby enable the flow of data in the network—the basic goal of the devices.

Networking devices generally have control ports which are designed to connect the device directly to a terminal and thereby enable initial configuration and basic monitoring and debugging. The control ports are typically implemented as some variety of RS-232 protocol and cannot directly participate in the normal flow of data through the networking data ports because the RS-232 port is not designed to carry TCP/IP traffic on these devices. Modern devices can be configured and monitored either through the control port or through the networking data ports.

The ability to configure devices through their networking data ports in addition to their control ports is convenient but creates potential security vulnerabilities in critical networks. FIG. 1 illustrates a prior art network with such network vulnerability. In FIG. 1, a plurality of interconnected networks is shown, generally at 100. An un-trusted data network 102, such as the Internet, is connected to a router 104. Router 104 is connected to a switch 106, which interconnects un-trusted data network 102 to external, low security computers 108.

Switch 106 is connected to a firewall 110, which provides a level of security, as is known in the art, between switch 106 and a second switch 112. Second switch 112 connects demilitarized zone (DMZ) computers 114 to external, low security computers 108 and to un-trusted network 102. A second firewall 116 provides a second level of security between switch 112 and switch 118. Switch 118 connects internal, higher security computers 120 to the rest of the network 110. As is known in the art, firewall 116 and firewall 110 help to prevent unauthorized access of DMZ computers 114 and internal, higher security computers 120. At the same time, firewall 116 and firewall 110 allow DMZ computers 114 and internal, higher security computers 120 to access the rest of network 100. All connection among network devices, networks and computers use TCP/IP.

In the scenario of FIG. 1, a network management system 130 monitors and controls network 100, over TCP/IP network 128. Network management system 130 is connected to networks 100 via a firewall 132 to attempt to prevent unauthorized access to network management system 130 from networks 100. Firewall 132 interconnects network management system 130 to router 104, switch 116, firewall 110, switch 112, firewall 116 and switch 118. All communications between network devices to and from firewall 132 and between firewall 132 and network management system 130 are through the network TCP/IP ports, the same ports that are used for data communication. Thus, communication between network management system 130 and any component of network 100 can be initiated from either end.

A vulnerability exists in the scenario of FIG. 1 because modern networks are partitioned by security devices (such as firewalls 110 and 116) to create security zones of differing levels of trust, with the most sensitive information being placed in the most trusted zones and the least secure on zones connected directly to the global public Internet. A management network 130 may connect to devices in different zones, which thus creates an opportunity for hackers to go straight from an insecure zone (e.g., un-trusted network 102) to the most trusted zone (e.g., internal higher security computers 120) via management network 130. Thus, a convenience for the network management team is also a vulnerability: hackers only have to hack through one firewall 132 to obtain access to any network device on networks 100.

Therefore, a problem exists in the art that secure networks may be vulnerable to intruders entering the secure area via the networking data port of the network management system.

### SUMMARY OF THE INVENTION

This problem is solved and a technical advance is achieved in the art by a system and method that effectively isolates a network management system from the network components that it monitors and controls. According to this invention, the network management system is connected to a port of each network component being monitored other than the network port. In this manner, connectivity between the management device and the network components is through a protocol which is not networkable, routable or both by the managed network devices.

According to one exemplary embodiment, a serial port on each of the network components is connected to a terminal server. The terminal server performs translations between communications to and from the serial ports and communications to and from the network management system. Advantageously, the serial ports comprise RS232 serial ports and the network management system communicates using TCP/IP.

According to this exemplary embodiment, no network device can initiate communication with the network management system. Advantageously, the network management system polls each component to determine its current status. The configurations of any network device can be “rolled back” by request of authorized administrators and can be checked against a master copy in the configuration management system by the management network to detect errors, unauthorized reconfiguration or hacking.

### BRIEF DESCRIPTION OF THE DRAWINGS

A more complete understanding of this invention may be obtained from a consideration of this specification taken in conjunction with the drawings, in which:

FIG. 1 is a block diagram of a prior art secured but vulnerable data network; and

FIG. 2 is a block diagram of a network system built in accordance with an exemplary embodiment of this invention.

### DETAILED DESCRIPTION

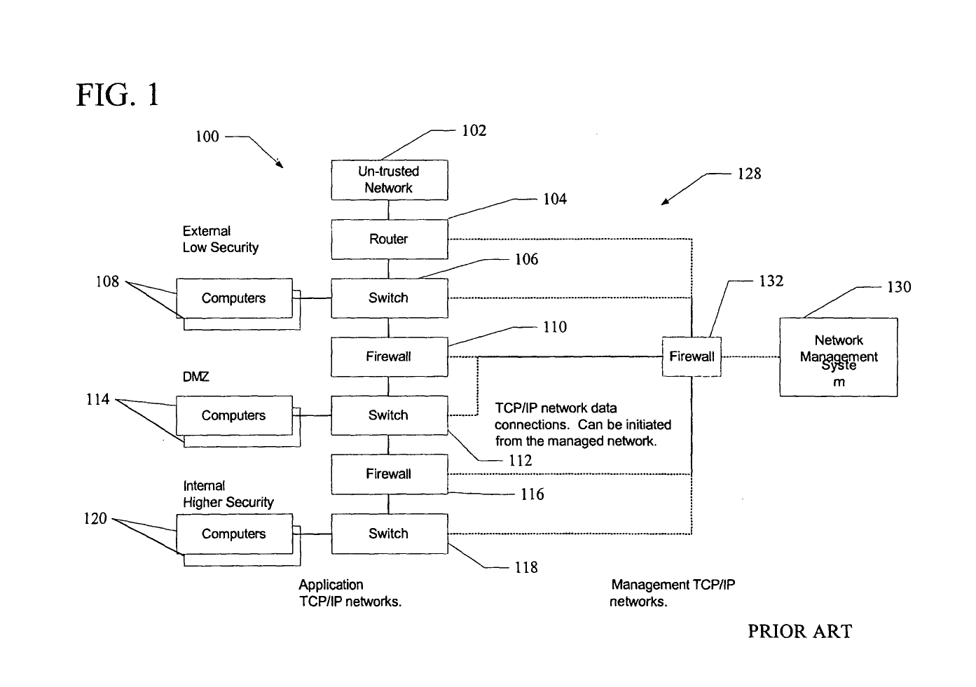

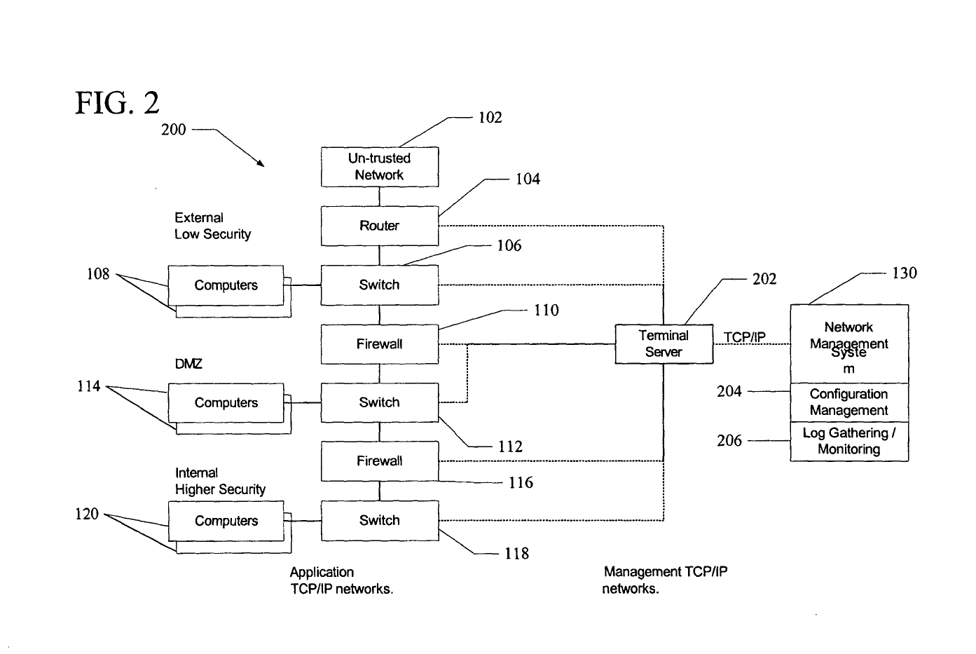

Turning now to FIG. 2, FIG. 2 is a block diagram of a network system built in accordance with an exemplary embodiment of this invention. As in FIG. 1, a plurality of interconnected networks is shown, generally at 200. An un-trusted data network 102, such as the Internet, is connected to a router 104. Router 104 is connected to a switch 106, which interconnects un-trusted data network 102 to external, low security computers 108.

Switch 106 is connected to a firewall 110, which provides a level of security between switch 106 and a second switch 112, as is known in the art. Second switch 112 connects DMZ computers 114 to external, low security computers 108 and to un-trusted network 102. A second firewall 116 provides a second level of security between switch 112 and switch 118. Switch 118 connects internal, higher security computers 120 to the rest of the network 110. As is known in the art, firewall 116 and firewall 110 help to prevent unauthorized access of DMZ computers 114 and internal, higher security computers 120. At the same time, firewall 116 and firewall 110 but allow DMZ computers 114 and internal, higher security computers 120 to access the rest of network 100.

A network management system 130 monitors and controls network 200. Instead of firewall 132 (FIG.1), a terminal server 202 interconnects network management system 130 to router 104, switch 116, firewall 110, switch 112, firewall 116 and switch 118. Terminal server 202 is, according to this exemplary embodiment, connected to serial ports on each of router 104, switch 116, firewall 110, switch 112, firewall 116 and switch 118. Thus, communication between terminal server 202 and the network devices is not through the same port as network communication.

According to this exemplary embodiment, the serial ports comprise RS-232 ports. Each port is polled by the terminal server 202 or through the terminal server 202 by command of network management system 130. In this manner, none of the network devices can initiate communication with network management system 130, which can compromise network security, as described above. Communication between terminal server 202 and network management system 130 is through network TCP/IP ports.

Network management system 130, according to this exemplary embodiment, also includes configuration management 204 and log gathering/monitoring 206. Network management system 130 may compare data from a network device to stored configurations in 204 and log data in 206.

In this manner, terminal server 202 coordinates the use of serial control ports on network devices for the monitoring, control and configuration management of such devices. A terminal server 202 can securely concentrate/multiplex control port traffic onto network management system 130. No connections other than dedicated control connections link devices exist between the managed network and the management network.

In one exemplary embodiment, console “screen scraping” and terminal scripting through programs (e.g., “GNU Expect”) may be used to automatically configure network devices by network management system 130. Configuration management for all devices managed by network management system 130 provides many advantages. For example, all versions of the configuration of each network device are stored in configuration management 204 on network management system 130 so that configurations may be staged prior to deployment on the managed network. Further, devices on the managed network may be rolled back to any previous configuration by the management network on request of authorized administrators. Devices on the managed network may periodically have their configurations checked against the master copy in the configuration management system by the management network to detect errors, unauthorized reconfiguration or hacking.

Using periodic sampling of network device configuration to checks the configuration of all network devices against the configuration management database 204 permits network management system 130 to check for tampering or unauthorized changes. Further, the network management system can monitor and control itself. Periodic sampling of network devices provides console log information 206 and central recording of that information.

In this manner, network management systems 130 can automatically check collected console logs to detect hacking activity. This exemplary embodiment also provides automatic management of the console port of managed network devices to switch between console logging and device configuration.

Advantageously, network management system 130 polls the managed network 200 in its operations—a more secure mode of operation than the managed network communicating directly with the management network.

Additionally, the network devices being managed do not need to be separately deployed—they may be bundled together as part of a larger appliance or networking device which requires secure internal management.

It is to be understood that the above-described embodiment is merely illustrative of the present invention and that many variations of the above-described embodiment can be devised by one skilled in the art without departing from the scope of the invention. For example, the protocol is not limited to RS-232. However, the protocol generally should be different from the default data networking protocol. An important point of this invention is that connectivity between the management devices and the managed devices is through a protocol which is not networkable/routable by the managed devices. It is therefore intended that such variations be included within the scope of the following claims and their equivalents.

What is claimed is:

1. A method for securely managing and monitoring a data network, said data network comprising a plurality of network components, said method comprising:
connecting a network management system to a non-network port of each of said network components;
managing each of said network components through said non-network port; and
monitoring each of said network components through said non-network port.

2. A method in accordance with claim 1 wherein connecting a network management system to a non-network port of each of said plurality of network components comprises:
connecting a network management system to a terminal server; and
connecting said terminal server to said non-network port of each of said network components.

3. A method in accordance with claim 2 further including establishing communication between said network management system and said terminal server via TCP/IP.

4. A method in accordance with claim 2 further including establishing communication between said terminal server and said plurality of network components via TCP/IP.

5. A method in accordance with claim 1 wherein said network management system includes a configuration manager, said method further comprising:
configuring said plurality of network components from said configuration manager through said non-network port of each of said network components.

6. A method in accordance with claim 1 wherein monitoring each of said network components comprises polling each of said network components.

7. A method in accordance with claim 1 wherein said network management system includes a system monitor, said method further comprising:
monitoring each of said plurality of network components by said system monitor.

8. A method in accordance with claim 7 wherein monitoring each of said plurality of network components by said system monitor comprise:
polling each of said network components by said system monitor.

9. A method in accordance with claim 1 wherein a terminal server is connected between said network management system and said plurality of network components and wherein said step of monitoring each of said plurality of network components comprises:
polling each of said plurality of network components by said terminal server responsive to said system monitor.

10. A method in accordance with claim 1 further comprising:
initiating communication between said network management system and said plurality of network components only from said network management system.

11. An apparatus for secure monitoring of network components in a data network comprising:
a plurality of network components, each of said plurality of network components having a data network port connected to said data network and each of said plurality of network components having a non-network port; and
a network management system connected to each of said plurality of network components at said non-network port and configured so that only said network management system may initiate communication with said plurality of network components.

12. An apparatus in accordance with claim 11 wherein said network management system is configured to poll each of said plurality of network components.

13. An apparatus in accordance with claim 11 further including a terminal server connected between said network management system and said plurality of network components.

14. An apparatus in accordance with claim 13 wherein said terminal server is configured to poll said plurality of network components.

15. An apparatus in accordance with claim 11 wherein said data network ports comprise serial ports.

16. An apparatus in accordance with claim 11 wherein said data network ports comprise RS232 ports.
